(19) United States
(12) Patent Application Publication
(10) Pub. No.: US 2009/0181208 A1
(43) Pub. Date: Jul. 16, 2009

(54) Lightweight Quick-Heating Fiberglass Mold with Integrated Cooling Channels and Method of Producing

(76) Inventor: Ronald Clifford Sahr, Little Falls, MN (US)

Correspondence Address: MERCHANT & GOULD PC, P.O. BOX 2903, MINNEAPOLIS, MN, 55402-0903, US

(21) Appl. No.: 12/236,233

(22) Filed: Sep. 23, 2008

Related U.S. Application Data
(60) Provisional application No. 60/995,237, filed on Sep. 24, 2007.

(51) Int. Cl. B32B 3/06

(52) U.S. Cl. 428/102

(57) ABSTRACT

A mold is provided with a schedule of layer materials including a gelcoat layer, a first resin layer, a second resin layer including reinforcing fibers, and at least one layer of woven fabric. The at least one layer of woven fabric including two decklayers bonded together by vertical piles, the piles woven into both decklayers thus forming an integral sandwich structure. The layer of woven fabric forming internal tubular voids when impregnated with resin. A method of producing such mold is also disclosed.

### CROSS REFERENCE TO RELATED APPLICATION

This application claims the benefit of U.S. Provisional Patent Application Ser. No. 60/995,237, filed Sep. 24, 2007, which application is hereby incorporated by reference in its entirety.

### TECHNICAL FIELD

The present disclosure relates to mold design, mold material selection, and mold construction, and in particular to fiberglass mold design, material selection, and construction.

### BACKGROUND

Molds are used in manufacturing a variety of commercial products. Often the molds are reused and make multiple copies of an article of manufacture. Multiple molds may be used simultaneously or sequentially in a manufacturing process. Molds typically are a negative (inverse) of the article of manufacture as will be explained below.

More specifically, molds are often used in the manufacture of composite shapes and structures such as fiberglass boat hulls and wind turbine blades. Such molds also include carbon fiber and carbon/glass hybrid composite boat hulls and wind turbine blades.

As shown in FIG. 1, creating a mold 200 typically involves creating a buck or a plug 100 which is shaped similar to the article of manufacture 500. An actual size of the buck or plug 100 may be scaled to account for shrinkage and/or expansion of the materials both of the mold 200 and of the article of manufacture 500. After the buck or plug 100 is created, a release agent is typically placed over the buck or plug 100. A gelcoat 210 is typically applied over the release agent. The gelcoat 210 is typically a resin without reinforcement and typically produces a hard smooth and durable working finish on the finished mold 200 which serves as a molding surface 250. One or more reinforcing layers 220, 230, 240 are typically applied over the gelcoat layer 210 to support the shape imparted on the gelcoat layer 210 after the buck or plug 100 has been removed. The reinforcing layers 220, 230, 240 typically provide overall structural integrity to the mold 200 and typically include a resin and reinforcing fibers. A frame (not shown) may be added to support the mold 200 and is typically mounted to the outer reinforcing layer 240.

Molds may be used to simply lay-up material within or upon the mold 200, the material taking the shape of the molding surface 250 (see FIG. 2). A curing process is used to solidify and rigidify the material 500 laid-up within or upon the mold 200 thus setting its shape (see FIG. 5). Once released from the mold 200, the material 500 may be further processed by trimming, machining, etc.

Open face molds are frequently used to manufacture fiberglass boat hulls. To make a hull with an open face mold, a layer of gel coat is frequently first applied to the mold. Next, a barrier layer is often applied to the gel coat. Finally a layer of fiberglass-reinforced resin is applied to the barrier layer. When the hull is removed from the mold, the gel coat provides a smooth, aesthetically pleasing outer surface of the hull. The barrier layer prevents the fiberglass from imprinting or pressing through the gel coat. The fiberglass provides the hull with structural rigidity. Additional rigidity is typically provided to the hull by stringer and flooring structures that are subsequently mounted within the hull.

A schedule of layer materials is often specified when designing a mold. A typical mold used to produce fiberglass boat hulls may have a schedule of layer materials as follows:

1. A 0.03±0.01 inch thick gelcoat layer 210;

2. A 0.19±0.03 inch thick first resin layer 220 with chop glass fiber reinforcement;

3. A 0.19±0.03 inch thick second resin layer 230 including glass fibers and calcium carbonate filler; and

4. A 0.5±0.06 inch thick third resin layer 230 including glass fibers and calcium carbonate filler.

It is often desired to efficiently heat and cool the mold. It is also desired to produce molds that are lightweight, have high strength-to-weight ratios, and/or have high stiffness-to-weight ratios. The present disclosure satisfies these and other desires.

### SUMMARY

One aspect of the present disclosure relates to a schedule of layer materials used within a mold. More particularly, the schedule of layer materials includes one or more layers of woven fabric each including two decklayers bonded together by vertical piles, the piles woven into both decklayers thus forming an integral sandwich structure. The layers of woven fabric are applied to and conform to a shape of a buck or a plug during the construction of the mold. In a first direction of the woven fabric, the vertical piles are relatively close to each other. In a second direction of the woven fabric, the vertical piles are significantly spaced from each other.

During construction of the mold, a thermo-set resin or other suitable resin is applied to the woven fabric. The woven fabric absorbs and becomes impregnated with the resin. It is thought that capillary forces within the piles cause the woven fabric to rise to a predetermined height when impregnated. The resin bridges across the impregnated vertical piles in the direction that they are relatively close to each other (the first direction). No bridging of the resin occurs between the vertical piles in the direction in which they are significantly spaced (the second direction). The resin bridging between the vertical piles in the first direction but not in the second direction creates tubular voids along the first direction. In certain embodiments the tubular voids have a rectangular cross-section. Spacing between the tubular voids is the same as the spacing between the vertical piles in the second direction.

A curing process is used to solidify and rigidify the impregnated woven fabric, preserving both the imparted shape of the buck or the plug and the tubular voids.

The tubular voids impart several important properties to the mold. Firstly, they reduce the amount of material within the mold thus reducing weight and thermal mass of the mold. Secondly, strength and rigidity of the mold is largely maintained thus resulting in an improved strength-to-weight ratio and stiffness-to-weight ratio of the mold. Thirdly, the voids provide a passage for cooling water in close proximity to molding surfaces of the mold. Cross-holes may be formed to join the tubular voids with each other and/or with features external to the woven fabric layer.

One or more layers of the woven fabric and associated tubular voids can be substituted for the resin layers including glass fibers mentioned above. In certain embodiments, two or more layers of the woven fabric are substituted for one layer.

### BRIEF DESCRIPTION OF THE DRAWINGS

FIG. 1 is a front elevation view of a prior art mold overlaid on a buck during the mold-making process;

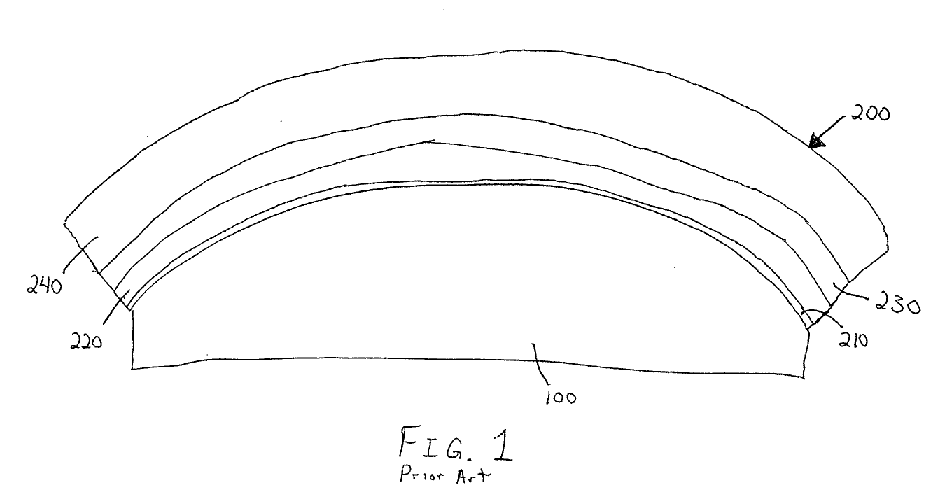

FIG. 2 is a front elevation view of the prior art mold of FIG. 1;

FIG. 3 is a front elevation view of another mold overlaid on the buck of FIG. 1 during the mold-making process;

FIG. 4 is a front elevation view of the mold of FIG. 3;

FIG. 5 is a front elevation view of the prior art mold of FIG. 1 molding a part;

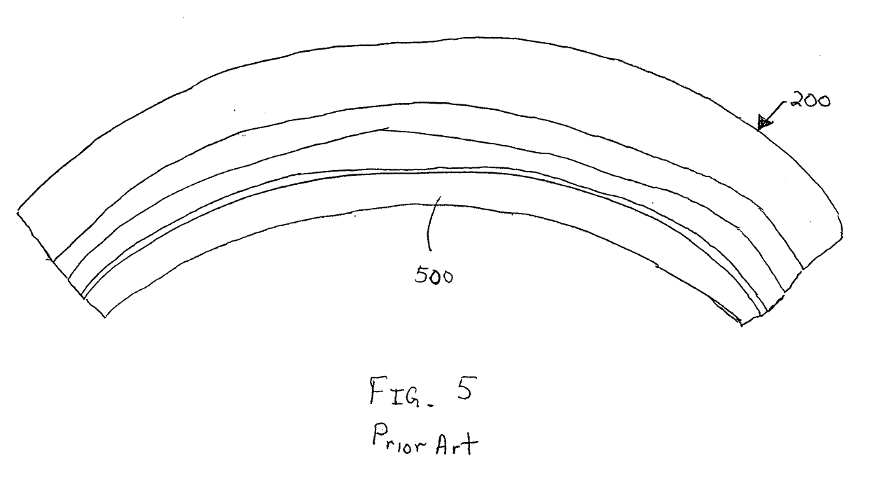

FIG. 6 is a front elevation view of the mold of FIG. 3 molding a part.

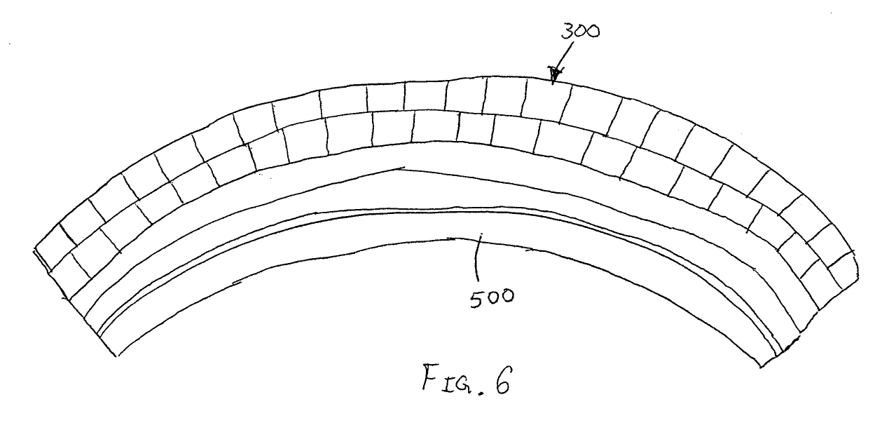

FIG. 7 is a schematic cross-sectional view of a resin transfer molding cell suitable for use in practicing the principles of the present invention; and

FIG. 8 is an enlarged detail view of a portion of the resin transfer molding cell of FIG. 7 including a portion of a mold.

### DETAILED DESCRIPTION

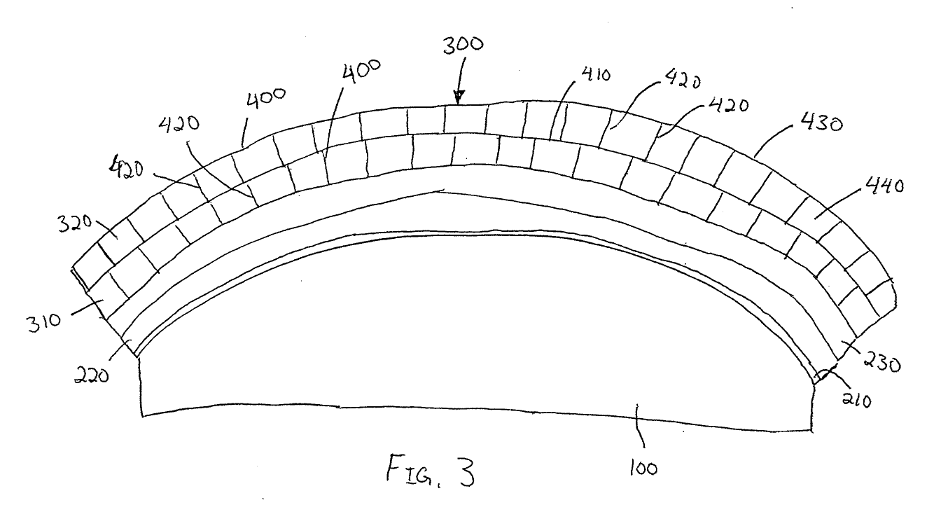

The present disclosure relates to molds and in particular to molds which produce fiberglass parts. In particular, a schedule of layer materials used within a mold 300 includes one or more layers of woven fabric 400 each including an upper decklayer 430 bonded together by vertical piles 420 to a lower decklayer 410. The piles 420 are woven into both decklayers 430, 410 thus forming an integral sandwich structure. An example of such woven fabric is given in U.S. Pat. No. 5,175,034, issued Dec. 29, 1992, which is incorporated herein by reference in its entirety. The layer(s) of woven fabric 400 are applied to and conform to a shape of a buck or a plug 100 during the construction of the mold 300 as shown in FIG. 3. In a first direction of the woven fabric 400 (perpendicular to FIG. 3), the vertical piles 420 are relatively close to each other. In a second direction of the woven fabric 400 (along the length of the fabric 400 in FIG. 3), the vertical piles 420 are significantly spaced from each other.

During construction of the mold 300, a thermo-set resin or other suitable resin is applied to the woven fabric 400. The woven fabric 400 absorbs and becomes impregnated with the resin. It is thought that capillary forces within the piles 420 cause the woven fabric 400 to rise to a predetermined height when impregnated. The resin bridges across the impregnated vertical piles 420 in the direction that they are relatively close to each other (the first direction). No bridging of the resin occurs between the vertical piles 420 in the direction in which they are significantly spaced (the second direction). The resin bridging between the vertical piles in the first direction but not in the second direction creates tubular voids or passages 440 along the first direction. In certain embodiments the tubular voids have a round, rectangular, or other shaped cross-section. Spacing between the tubular voids 440 is the same as the spacing between the vertical piles 420 in the second direction.

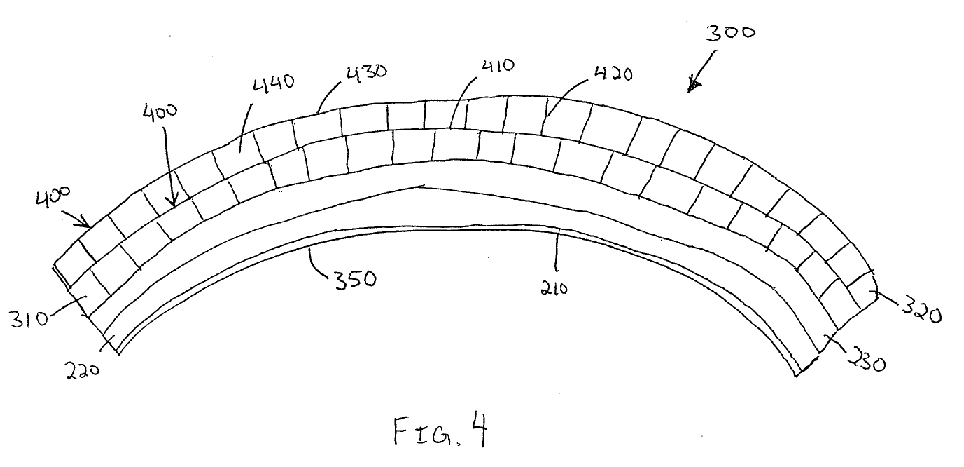

A curing process is used to solidify and rigidify the impregnated woven fabric 400, preserving both the imparted shape of the buck or the plug 100 and the tubular voids 440. After the mold 300 has cured, it is removed from the buck or plug 100 as shown in FIG. 4. A framework (not shown) may be applied to the mold 300 to further strengthen the mold 300 and to hold several molds together. The framework may also aid in handling the mold 300.

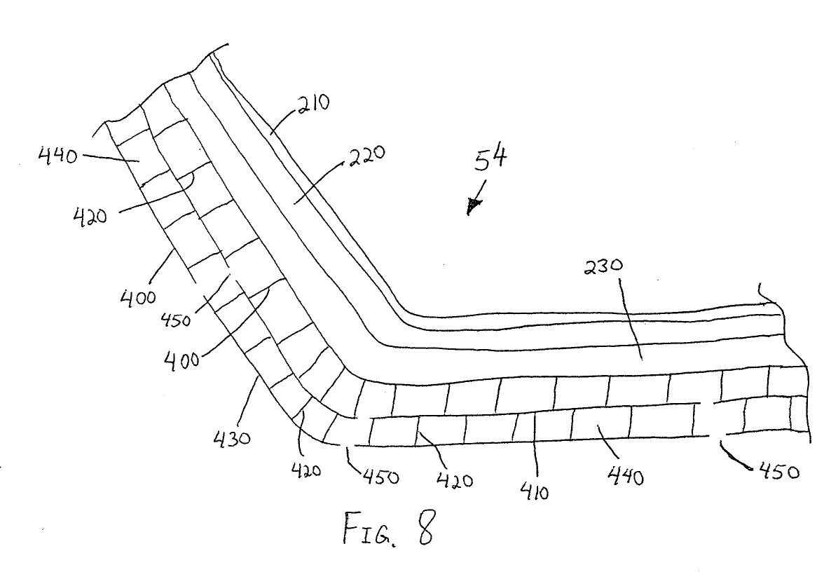

The tubular voids 440 impart several important properties to the mold 300, several of which are listed below. Firstly, they reduce the amount of material within the mold 300 thus reducing weight and thermal mass of the mold 300. Secondly, strength and rigidity of the mold 300 is largely maintained as compared to the prior art mold 200, thus resulting in an improved strength-to-weight ratio and stiffness-to-weight ratio of the mold 300. Thirdly, the voids 440 provide a passage for cooling water in close proximity to a molding surface 350 of the mold 300. Cross-holes 450 may be formed to join the tubular voids with each other and/or with features external to the woven fabric layer (see FIG. 8).

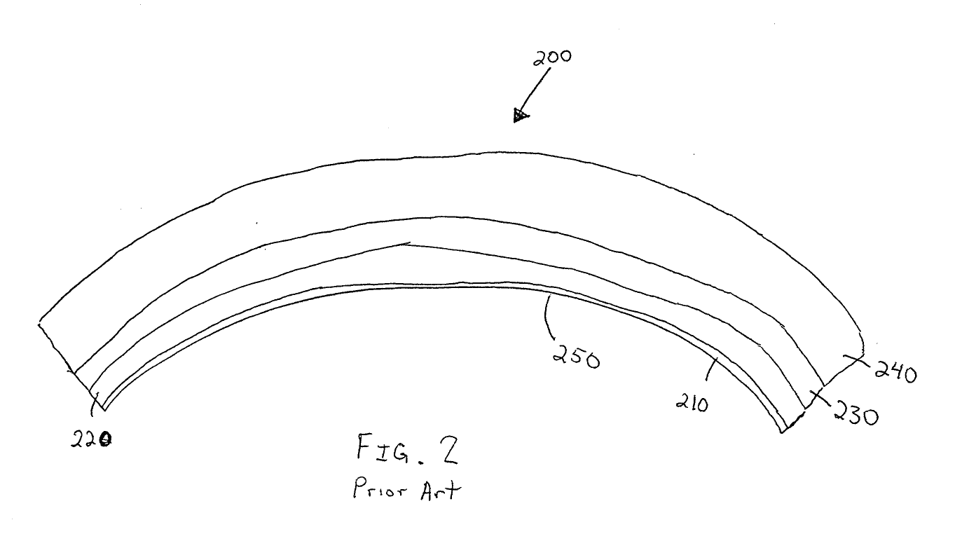

One or more layers of the impregnated woven fabric 400 and associated tubular voids 440 can be substituted for one or more of the resin layers including reinforcing fibers 230, 240 mentioned above. In certain embodiments, two layers 310 and 320 of the woven fabric 400 are substituted for the fourth layer 240 above (see FIGS. 2 and 4).

An example schedule of layer materials is given below. A typical mold used to produce fiberglass boat hulls may use such an example schedule of layer materials as follows:

1. A 0.03±0.01 inch thick gelcoat layer;

2. A 0.1±0.05 inch thick first resin layer with chop glass fiber reinforcement; the layer serving as a barrier layer keeping subsequent layers from imprinting on the gelcoat layer;

3. A 0.1±0.05 inch thick second resin layer including glass fibers and calcium carbonate filler; the layer may serve as a barrier layer keeping subsequent layers from imprinting on the gelcoat layer;

4. A 0.14±0.06 inch thick third resin layer with chop glass fiber reinforcement;

5. A first layer of approximately 0.25 inch thick ParaGlass woven fabric produced by Parabeam® b.v. of 5700 AC Helmond, The Netherlands. The ParaGlass impregnated with resin;

6. A second layer of approximately 0.25 inch thick ParaGlass woven fabric produced by Parabeam® b.v. of 5700 AC Helmond, The Netherlands. The ParaGlass impregnated with resin; and

7. A 0.05±0.02 inch thick resin layer with fluff.

A mold made of the example schedule of layer materials may be further supported by a frame, for example a steel frame.

The tubular voids formed in layers 5 and 6 above may be fitted with cross-holes and/or plumbing to allow water cooling of the mold.

The structural properties of the impregnated woven fabric 400 and associated tubular voids 440 are different between the first direction (along the tubular void 440) and the second direction. Thus, the orientation of the woven fabric 400 may be chosen to best suit the mold requirements at hand. Furthermore, alternate orientations of the woven fabric 400 may be selected between multiple layers.

In addition to the benefits disclosed above, other benefits may be gained by including one or more layers of the resin impregnated woven fabric and associated tubular voids within a mold. These include material and labor cost savings over a corresponding prior art mold as well as higher strength and stiffness, a faster mold build time, better impact resistance, and a lighter supporting frame. Impact resistance is provided to the overall mold in that the tubular voids may locally deform and absorb hits.

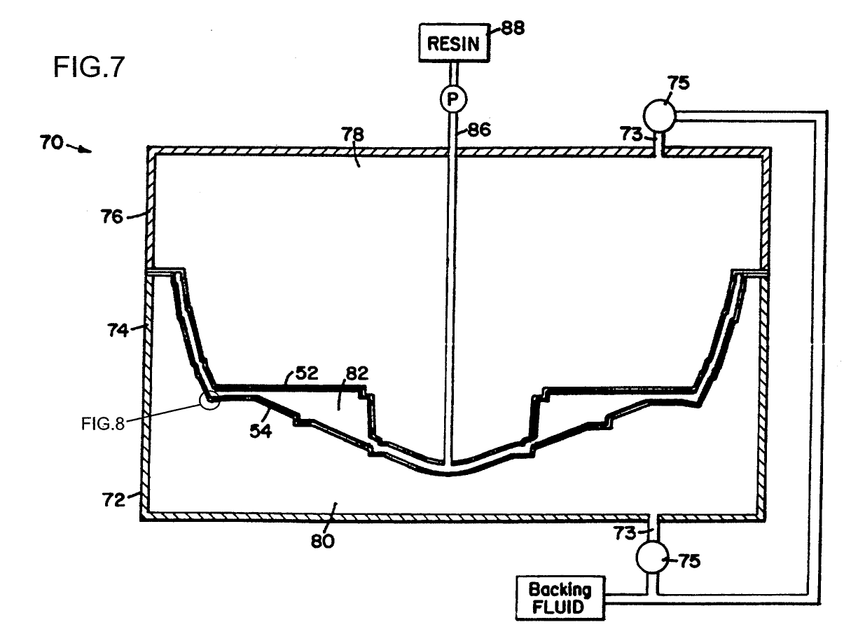

One or more layers of the impregnated woven fabric 400 and associated tubular voids 440 can be incorporated within molds used in a process of resin transfer molding as disclosed in U.S. Pat. No. 6,367,406, issued Apr. 9, 2002, which is incorporated herein by reference in its entirety. FIG. 7 shows a cross-section of an example molding cell 70 incorporating the technique of resin transfer molding. The process includes a male mold 52 and a female mold 54 which may each incorporate one or more layers of the impregnated woven fabric 400 and associated tubular voids 440 disclosed above. FIG. 8 is a detail enlargement of FIG. 7 illustrating the cross-holes 450 of the female mold 54 interconnecting the tubular voids 440 as well as connecting the tubular voids 440 to a bottom fluid chamber 80. The example molding cell 70 includes a molding chamber 82 formed by molding surfaces of a male mold 52 together with the female mold 54 and shaped to form and mold the surfaces of a boat hull. Additional features included within the molding cell 70 include a source of resin 88, a sprue 86, a substantially rigid outer support housing 72 having a bottom portion 74 and a removable top portion 76, a top fluid chamber 78, inlets 73, and valves 75. For more detailed information on the example molding cell 70, please see U.S. Pat. No. 6,367,406, issued Apr. 9, 2002.

The resin impregnated woven fabric with associated tubular voids may also be used where inserts and cores such as honeycomb, steel, and balsa wood inserts and cores have been traditionally used within molds. This provides benefits over traditional cores in that the resin and fibers of the impregnated woven fabric match the surrounding fiberglass and thus induce minimal thermal stress resulting in longer mold life. Another advantage is the resin impregnated woven fabric conforms and contours well to any shape unlike traditional core material. Still another advantage is provided by the resin impregnated woven fabric being chemically similar to the surrounding fiberglass, thus resulting in superior bond strength.

The above specification provides examples of how certain inventive aspects may be put into practice. It will be appreciated that the inventive aspects can be practiced in other ways than those specifically shown and described herein without departing from the spirit and scope of the inventive aspects of the present disclosure.

What is claimed is:

1. A fiberglass mold for molding a fiberglass molded part, the fiberglass mold comprising:
a gelcoat layer, the gelcoat layer providing a molding surface adjacent the fiberglass molded part when molding;
at least one layer of resin impregnated woven fabric including a first decklayer bonded together with a second decklayer by vertical piles, the vertical piles woven into both decklayers;
wherein the vertical piles are closer to each other in a first direction of the woven fabric spaced farther from each other in a second direction of the woven fabric;
wherein the resin impregnated woven fabric rises to a predetermined height when impregnated;
wherein the impregnating resin bridges across the vertical piles in the first direction and no impregnating resin bridges between the vertical piles in the second direction; and
a barrier layer positioned between the gelcoat layer and the first decklayer.

2. A fiberglass mold comprising:
a gelcoat layer;
a construction of resin impregnated fabric material including a first decklayer connected to a second decklayer by vertical structures, the construction of resin impregnated fabric material defining rows of passages defined between the first and second decklayers; and
a barrier layer positioned between the gelcoat layer and the first decklayer.
